(19) United States
(12) Patent Application Publication
(10) Pub. No.: US 2010/0234973 A1
(43) Pub. Date: Sep. 16, 2010

(54) PATTERN VERIFYING METHOD, METHOD OF MANUFACTURING A SEMICONDUCTOR DEVICE AND PATTERN VERIFYING PROGRAM

(76) Inventor: Kenji KONOMI, New York, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/704,373

(22) Filed: Feb. 11, 2010

(30) Foreign Application Priority Data
Mar. 11, 2009 (JP) 2009-58252

(51) Int. Cl. G06F 17/50

(52) U.S. Cl. 700/98; 716/5; 716/11; 716/12; 700/110; 700/121

(57) ABSTRACT

A specification of a layout of a layout pattern arranged on a layer is set based on three-dimensional structures of layers of a semiconductor integrated circuit. It is verified whether a layout pattern formed on a wafer based on design layout data subjected to proximity correction satisfies the specification.

### CROSS-REFERENCE TO RELATED APPLICATIONS

This application is based upon and claims the benefit of priority from the prior Japanese Patent Application No. 2009-58252, filed on Mar. 11, 2009; the entire contents of which are incorporated herein by reference.

### BACKGROUND OF THE INVENTION

1. Field of the Invention

The present invention relates to a pattern verifying method, a method of manufacturing a semiconductor device, and a pattern verifying program, and, more particularly is suitably applied to a method of verifying a layout pattern subjected to optical proximity correction while taking into account three-dimensional structures of layers of a semiconductor integrated circuit.

2. Description of the Related Art

According to microminiaturization of semiconductor integrated circuits in recent years, in a photolithography process in a semiconductor manufacturing process, it is becoming difficult to perform transfer of patterns with fidelity simply by reducing wavelength of exposure light wavelength of an exposing apparatus and increasing numerical aperture (NA). To compensate for such deterioration in transfer fidelity of patterns, optical proximity correction processing and process proximity correction processing, which includes a proximity effect in processes other than the photolithography process, are carried out. To check whether such correction processing is appropriately performed, pattern verification processing for performing a lithography simulation using a photomask manufactured from mask data after correction and checking whether a desired shape can be obtained is simultaneously performed.

For example, Japanese Patent Application Laid-Open No. 2005-181523 discloses a design pattern correcting method for correcting a design pattern taking into account a process margin among a plurality of layers of a semiconductor integrated circuit.

In the pattern verification processing in the past, it is possible to confirm that overlap of layout patterns between two different layers can be secured. However, because the layout patterns in the layers are treated in a planar manner, when there is a step or the like in an actual layout pattern, the layout pattern deviates from an overlap specification required in an actual device.

In the method disclosed in Japanese Patent Application Laid-Open No. 2005-181523, when a design pattern is corrected, although the process margin among the layers of the semiconductor integrated circuit is taken into account, three-dimensional structures of layers of the semiconductor integrated circuit are not taken into account.

### BRIEF SUMMARY OF THE INVENTION

A pattern verifying method according to an embodiment of the present invention comprises: setting, based on three-dimensional structures of layers of a semiconductor integrated circuit, a specification concerning a layout of a layout pattern arranged on a layer; and verifying whether a pattern transferred on a wafer based on design layout data of the layout pattern subjected to proximity correction satisfies the specification.

A method of manufacturing a semiconductor device according to an embodiment of the present invention comprises: setting, based on three-dimensional structures of layers of a semiconductor integrated circuit, a specification concerning a layout of a layout pattern arranged on a layer; verifying whether a pattern transferred on a wafer based on design layout data subjected to proximity correction satisfies the specification; and transferring a pattern onto a semiconductor substrate based on the design layout verified as satisfying the specification.

A pattern verifying program according to an embodiment of the present invention comprises: causing a computer to execute verifying whether a pattern transferred on a wafer based on a design layout data subjected to proximity correction satisfies a specification concerning a layout of a layout pattern set based on three-dimensional structures of layers of a semiconductor integrated circuit.

### BRIEF DESCRIPTION OF THE DRAWINGS

FIG. 1 is a block diagram of the schematic configuration of a system to which a pattern verifying method according to a first embodiment of the present invention is applied;

FIG. 2 is a block diagram of an example of the hardware configuration of a pattern verifying apparatus according to a second embodiment of the present invention;

FIG. 3A is a plan view of the schematic configuration of a semiconductor device to which a pattern verifying method according to a third embodiment of the present invention is applied;

FIG. 3B is a sectional view of the schematic configuration of the semiconductor device to which the pattern verifying method according to the third embodiment is applied;

FIG. 4A is a plan view of the schematic configuration of a semiconductor device to which a pattern verifying method according to a fourth embodiment of the present invention is applied; and

FIG. 4B is a sectional view of the schematic configuration of the semiconductor device to which the pattern verifying method according to the fourth embodiment is applied.

### DETAILED DESCRIPTION OF THE INVENTION

Exemplary embodiments of the present invention are explained in detail below with reference to the accompanying drawings. The present invention is not limited by the embodiments.

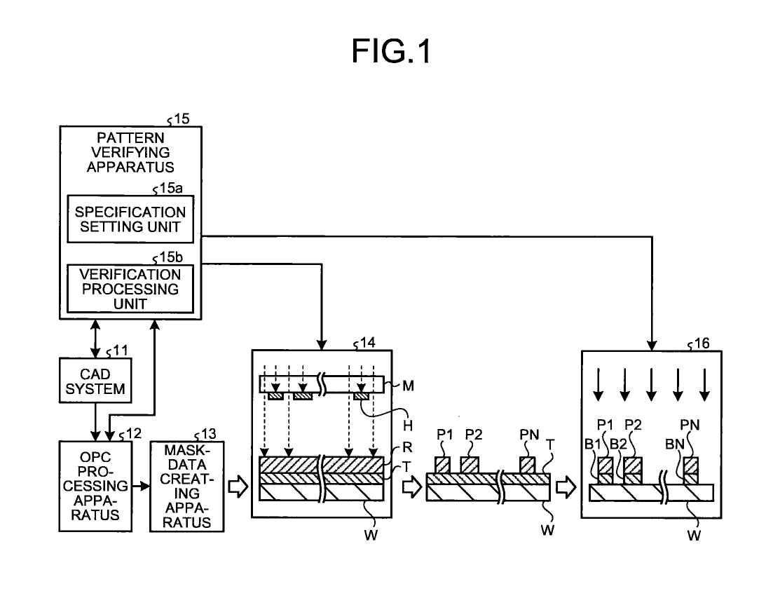

FIG. 1 is a block diagram of the schematic configuration of a system to which a pattern verifying method according to a first embodiment of the present invention is applied.

In FIG. 1, a pattern verifying apparatus 15 includes a specification setting unit 15a and a verification processing unit 15b. A computer aided design (CAD) system 11, an optical proximity correction (OPC) processing apparatus 12, and an exposing apparatus 14 are connected to the pattern verifying apparatus 15.

The CAD system 11 can create design layout data corresponding to layout patterns of layers of a semiconductor integrated circuit. Examples of the design layout data include dimensions and arrangement positions of the layout patterns of the layers. A data format of the design layout data, for example, text coordinate data, GDS data, oasis data, HSS data, or image data (Tiff, Bit Map, or Jpeg) can be used.

The OPC processing apparatus 12 can apply optical proximity correction processing to the layout patterns specified by the design layout data created by the CAD system 11. A mask-data creating apparatus 13 can create mask data corresponding to the design layout data subjected to the optical proximity correction processing. The exposing apparatus 14 can expose a resist film R formed on a wafer W to light via a photomask M on which a light blocking film H is formed. In the photomask M, mask patterns specified by the mask data created by the mask-data creating apparatus 13 are formed in the light blocking film H. An etching apparatus 16 can etch a processing layer T with resist patterns P1 to PN formed on the processing layer T as masks.

As the wafer W, for example, a semiconductor wafer formed of Si or the like can be used. Examples of the processing layer T include a polysilicon film used for gate electrodes, resistors, and the like, an AL film and a Cu film used for wires, contact electrodes, and the like, and a silicon oxide film and a silicon nitride film used as insulting layers.

The pattern verifying apparatus 15 can verify whether a pattern transferred on a wafer based on the design layout data subjected to optical proximity correction by the OPC processing apparatus 12 satisfies specifications concerning the layouts of the layers of the semiconductor integrated circuit. When specifications concerning layouts of layout patterns of the layers of the semiconductor integrated circuit are set, three-dimensional structures of the layers of the semiconductor integrated circuit can be taken into account. As a verification method by the pattern verifying apparatus 15, a lithography simulation or a process simulation can be used.

Specifically, the specification setting unit 15a can set the specifications concerning the layouts of the layout patterns arranged in the layers. Examples of the three-dimensional structures of the layers include steps, a tilt, and unevenness of the layers.

The verification processing unit 15b can verify whether the pattern transferred on the wafer based on the design layout data subjected to the optical proximity correction by the OPC processing apparatus 12 satisfies the specifications set by the specification setting unit 15a. Examples of the specifications concerning the layouts of the layout patterns include specifications concerning an area of an overlapping section between layout patterns of layers different from each other. When the specifications are set, dimension information of the three-dimensional structures and characteristic values of materials of the layers of the semiconductor integrated circuit can be used. Alternatively, the dimension information of the three-dimensional structures and functions of the characteristic values of the materials of the layers of the semiconductor integrated circuit can also be used.

The CAD system 11 creates design layout data corresponding to the layout patterns of the layers of the semiconductor integrated circuit and sends the design layout data to the OPC processing apparatus 12. The OPC processing apparatus 12 applies the optical proximity correction to the layout patterns obtained from the design layout data created by the CAD system 11 and sends the layout patterns to the mask-data creating apparatus 13. When the OPC processing apparatus 12 performs the optical proximity correction, the OPC processing apparatus 12 can correct the design layout data such that, when photolithography is performed with exposure conditions such as an exposure amount and a focus position fixed to best conditions, a dimension difference between layout patterns obtained by the photolithography and the layout patterns obtained from the design layout data is minimized.

After the OPC processing apparatus 12 performs the optical proximity correction of the layout patterns, the pattern verifying apparatus 15 verifies the layout patterns subjected to the optical proximity correction. In the verification of the layout patterns, the pattern verifying apparatus 15 determines whether the specifications set by the specification setting unit 15a are satisfied even if the photolithography is performed when there is fluctuation in the exposure conditions such as an exposure amount and a focus position and a dimension of a mask pattern. When the specification setting unit 15a sets the specifications, the specification setting unit 15a takes into account the three-dimensional structures of the layers of the semiconductor integrated circuit. Examples of the three-dimensional structures of the layers of the semiconductor integrated circuit include steps and a tilt of contact regions in the layers. During the verification of the layout patterns, a lithography simulator can be used to calculate layout patterns after lithography when there is the fluctuation in the exposure conditions and the dimension of the mask pattern.

When it is determined that the layout patterns subjected to the optical proximity correction by the OPC processing apparatus 12 do not satisfy the specifications set by the specification setting unit 15a, the pattern verifying apparatus 15 can instruct the OPC processing apparatus 12 to perform the optical proximity correction again. Alternatively, the pattern verifying apparatus 15 can also instruct the CAD system 1 to correct the design layout data.

After the pattern verifying apparatus 15 verifies the layout patterns subjected to the optical proximity correction by the OPC processing apparatus 12, the mask-data creating apparatus 13 creates mask data corresponding to the layout patterns verified by the pattern verifying apparatus 15. In the photomask M, a mask pattern specified by the mask data created by the mask-data creating apparatus 13 is formed in the light blocking film H.

After the photomask M having the light blocking film M formed thereon is arranged on the exposing apparatus 14, when the wafer W having the resist film R formed thereon via the processing layer T is arranged on the exposing apparatus 14, the exposing apparatus 14 performs exposure of the resist film R via the photomask M. The resist film R exposed by the exposing apparatus 14 is developed, whereby the resist film R is patterned and the resist patterns P1 to PN are formed on the processing layer T.

After the resist patterns P1 to PN are formed on the processing layer T, the wafer W is arranged on the etching apparatus 16. The etching apparatus 16 etches the processing layer T with the resist patterns P1 to PN as masks to form etching patterns B1 to BN on the wafer W. As the etching patterns B1 to BN, for example, wiring patterns, trench patterns, or contact patterns can be formed. After the etching patterns B1 to BN are formed on the wafer W, the wafer W is taken out from the etching apparatus 16. The resist patterns P1 to PN are removed from the etching patterns B1 to BN by a method such as ashing.

When specifications are set by the specification setting unit 15a, it is possible to increase a planar area of the layout patterns in appearance by causing the specification setting unit 15a to take into account the three-dimensional structures of the layers of the semiconductor integrated circuit. Therefore, it is unnecessary to secure a margin more than necessary at a design stage of the layout patterns and redundancy in layout design can be reduced. This makes it possible to realize high integration of the semiconductor integrated circuit without deteriorating the yield of the semiconductor integrated circuit.

When it is determined that the layout patterns subjected to the optical proximity correction by the OPC processing apparatus 12 do not satisfy the specifications set by the specification setting unit 15a, the pattern verifying apparatus 15 can instruct the OPC processing apparatus 12 to change process conditions. For example, the pattern verifying apparatus 15 can instruct the exposing apparatus 14 to change the exposure conditions such as an exposure amount and a focus position. Alternatively, the pattern verifying apparatus 15 can instruct the etching apparatus 16 to change etching conditions such as etching time, etching energy, and a flow rate of etching gas.

In the embodiment explained above, the method of determining, when the layout patterns subjected to the optical proximity correction are verified, whether the layout patterns after lithography satisfy the specifications is explained. However, it is also possible to determine whether the layout patterns after etching satisfy the specifications. A process simulator can be used to calculate layout patterns after etching when there is fluctuation in the etching conditions.

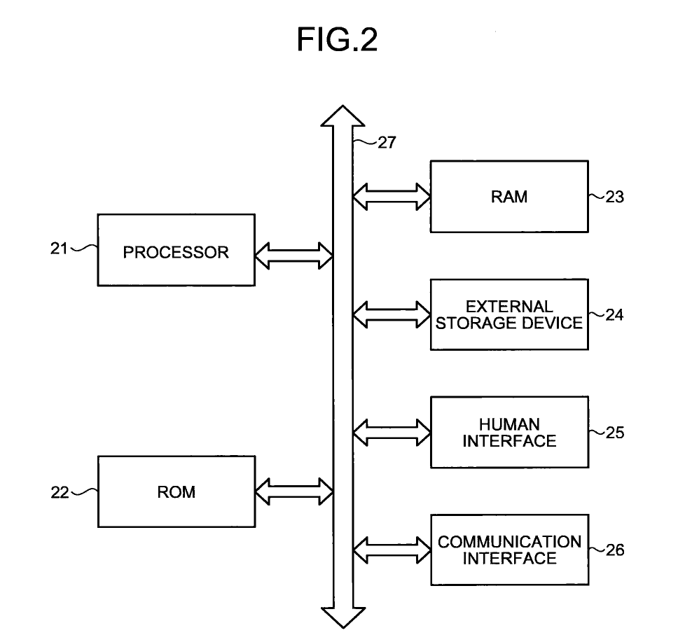

FIG. 2 is a block diagram of an example of the hardware configuration of a pattern verifying apparatus according to a second embodiment of the present invention.

In FIG. 2, the pattern verifying apparatus 15 shown in FIG. 1 can include a processor 21 including a central processing unit (CPU), a read only memory (ROM) 22 having stored therein fixed data, a random access memory 23 that provides the processor 21 with a work area or the like, an external storage device 24 that stores a computer program for causing the processor 21 to operate and various data, a human interface 25 that performs mediation between a human and a computer, and a communication interface 26 that provides means for communication with the outside. The processor 21, the ROM 22, the RAM 23, the external storage device 24, the human interface 25, and the communication interface 26 are connected to one another via a bus 27.

As the external storage device 24, for example, magnetic disks such as a hard disk, optical disks such as a digital versatile disk (DVD), and portable semiconductor storage devices such as a USB memory and a memory card can be used. As the human interface 25, for example, a keyboard and a mouse as input interfaces, a display and a printer as output interfaces, and the like can be used. As the communication interface 26, for example, a LAN card, a modem, a router, and the like for connection to the Internet, a local area network (LAN), and the like can be used.

The processor 21 can realize, by executing a pattern verifying program, functions executed by the specification setting unit 15a and the verification processing unit 15b shown in FIG. 1. The computer program for causing the processor 21 to operate can be stored in the external storage device 24 and read into the RAM 23 when the computer program is executed, can be stored in the ROM 22 in advance, or can be acquired via the communication interface 26.

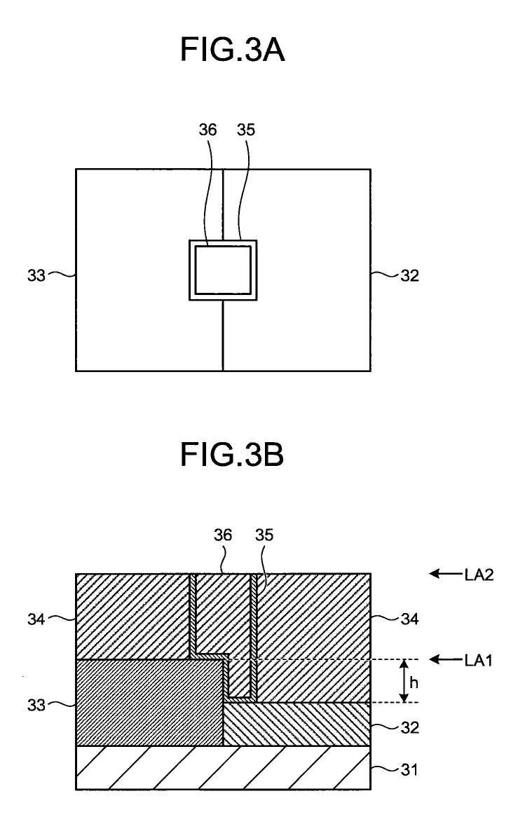

FIG. 3A is a plan view of the schematic configuration of a semiconductor device to which a pattern verifying method according to a third embodiment of the present invention is applied. FIG. 3B is a sectional view of the schematic configuration of the semiconductor device to which the pattern verifying method according to the third embodiment is applied.

In FIGS. 3A and 3B, a device isolation insulating layer 32 is embedded in a semiconductor substrate 31. A material of the semiconductor substrate 31 is not limited to Si and can be selected out of, for example, Ge, SiGe, SiC, SiSn, PbS, GaAs, InP, GaP, GaN, ZnSe, and GaInAsP. As the device isolation insulating layer 32, for example, a shallow trench isolation (STI) structure can be used.

An impurity diffusing layer 33 is formed on the semiconductor substrate 41 device-isolated by the device isolation insulating layer 32. An inter-layer insulating film 34 is formed on the device isolation insulating layer 32 and the impurity diffusing layer 33. The device isolation insulating layer 32 is arranged in a position lower than the surface of the semiconductor substrate 31. A step is formed between the device isolation insulating layer 32 and the impurity diffusing layer 33. The impurity diffusing layer 33 can be used as, for example, a source/drain layer of a field effect transistor.

A contact electrode 36 is embedded in the interlayer insulating film 34 via a barrier metal film 35. As a material of the barrier metal film 35, for example, TiN can be used. As a material of the contact electrode 36, for example, W, Al, or Cu can be used. The contact electrode 36 is arranged to extend over the step between the device isolation insulating layer 32 and the impurity diffusing layer 33. The contact electrode 36 is set in contact with a side of the impurity diffusing layer 33 via the barrier metal film 35.

A layout pattern of the impurity diffusing layer 33 is formed in a layer LA1. A layout pattern of the contact electrode 36 is formed in a layer LA2.

When the specification setting unit 15a shown in FIG. 1 sets a specification concerning an area of an overlapping portion of the impurity diffusing layer 33 and the contact electrode 36, it is possible to cause the specification setting unit 15a to take into account a three-dimensional structure of the impurity diffusing layer 33 of the layer LA1.

For example, when the contact electrode 36 is set in contact with the side of the impurity diffusing layer 33 via the barrier metal film 35, it is possible to cause not only a section set in contact with the plane of the impurity diffusing layer 33 but also a section set in contact with the side of the impurity diffusing layer 33 to contribute to a reduction in contact resistance.

Therefore, a specification SP concerning the area of the overlapping section between the impurity diffusing layer 33 and the contact electrode 36 can be represented by the following Formula (1):

SP=S+f(h) (1)

where, h represents the step of the impurity diffusing layer 33, f(h) represents a function having h as a variable, and S represents a contact area on the plane between the impurity diffusing layer 33 and the contact electrode 36. The step h of the impurity diffusing layer 33 can be obtained by a simulation or accrual measurement.

As explained above, Formula (1) is used as the specification SP concerning the area of the overlapping section between the impurity diffusing layer 33 and the contact electrode 36. Consequently, even when the contact area S on the plane between the impurity diffusing layer 33 and the contact electrode 36 is insufficient, it is possible to satisfy the specification SP depending on a value of the function f(h).

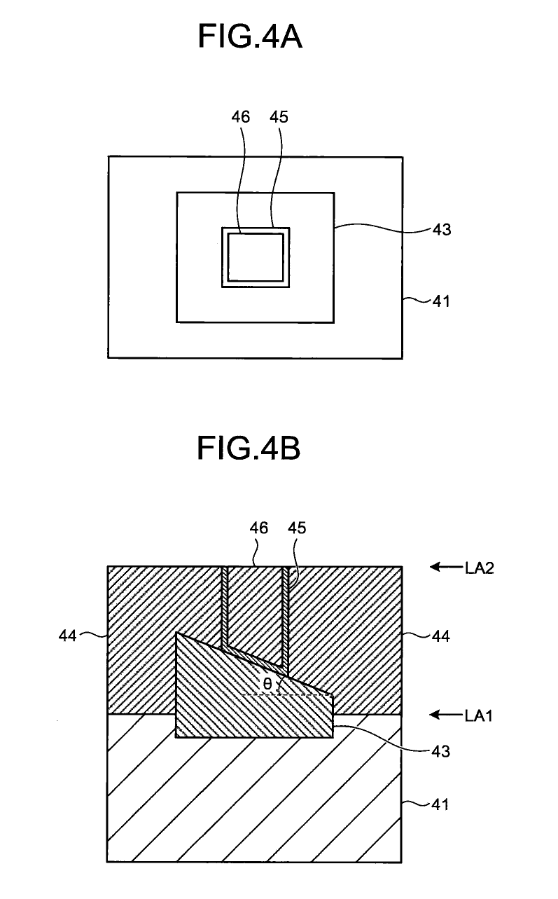

FIG. 4A is a plan view of the schematic configuration of a semiconductor device to which a pattern verifying method according to a fourth embodiment of the present invention is applied. FIG. 4B is a sectional view of the schematic configuration of the semiconductor device to which the pattern verifying method according to the fourth embodiment is applied.

In FIGS. 4A and 4B, a selective epitaxial layer 43 is selectively formed on a semiconductor substrate 41. The selective epitaxial layer 43 is formed to incline with respect to the semiconductor substrate 41. The selective epitaxial layer 43 can be used as a source/drain layer of a field effect transistor. When a material of the semiconductor substrate 41 is Si, as a material of the selective epitaxial layer 43, for example, SiGe can be used. An interlayer insulating film 44 is formed on the selective epitaxial layer 43.

A contact electrode 46 is embedded in the interlayer insulating film 44 via a barrier metal film 45. The contact electrode 46 is arranged on the selective epitaxial layer 43.

A layout pattern of the selective epitaxial layer 43 is formed in a layer LA1. A layout pattern of the contact electrode 46 is formed in a layer LA2.

When the specification setting unit 15a shown in FIG. 1 sets a specification concerning an area of an overlapping section between the selective epitaxial layer 43 and the contact electrode 46, it is possible to cause the specification setting unit 15a to take into account a three-dimensional structure of the selective epitaxial layer 43 of the layer LA1.

For example, when the selective epitaxial layer 43 inclines with respect to the semiconductor substrate 41, an area of the contact electrode 46 set in contact of the selective epitaxial layer 43 via the barrier metal film 45 is larger than an area on the plane of the selective epitaxial layer 43.

Therefore, a specification SP concerning the area of the overlapping section between the selective epitaxial layer 43 and the contact electrode 46 can be represented by the following Formula (2):

SP=S/cos θ (2)

where, θ represents a tilt angle of the selective epitaxial layer 43 and S represents a contact area on the plane between the selective epitaxial layer 43 and the contact electrode 46. The tilt angle θ of the selective epitaxial layer 43 can be obtained by a simulation or actual measurement.

As explained above, Formula (2) is used as the specification SP concerning the area of the overlapping section between the selective epitaxial layer 43 and the contact electrode 46. Consequently, even when the contact area S on the plane between the selective epitaxial layer 43 and the contact electrode 46 is insufficient, it is possible to satisfy the specification SP depending on a value of the tilt angle θ.

When the specification setting unit 15a shown in FIG. 1 uses dimension information of three-dimensional structures of the layers to set specifications, in some case, a different process is used according to the threshold voltage of a field effect transistor. Therefore, when the threshold voltage of the field effect transistor is different, a step of a source/drain is different. Therefore, as the dimension information of the three-dimensional structure of the layers, a different value can be used for each threshold voltage of the field effect transistor.

Further, when the specification setting unit 15a shown in FIG. 1 uses the dimension information of the three-dimensional structures of the layers to set specifications, in some case, different processes are used for an N-channel field effect transistor and a P-channel field effect transistor. Therefore, because a step of a source/drain is different between the N-channel field effect transistor and the P-channel field effect transistor, as the dimension information of the three-dimensional structures of the layers, different values can be used for the N-channel field effect transistor and the P-channel field effect transistor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern verifying method comprising:
setting, based on three-dimensional structures of layers of a semiconductor integrated circuit, a specification concerning a layout of a layout pattern arranged on a layer; and
verifying whether a pattern transferred on a wafer based on design layout data of the layout pattern subjected to proximity correction satisfies the specification.

2. The pattern verifying method according to claim 1, wherein the specification concerning the layout is a specification concerning an area of an overlapping section between patterns on the wafer of layers different from each other.

3. The pattern verifying method according to claim 2, wherein the area of the overlapping section between the patterns on the wafer is set based on a function having an amount of an unevenness of the layers as a variable.

4. The pattern verifying method according to claim 2, wherein the area of the overlapping section between the patterns on the wafer is set based on a function having a tilt of the layers as a variable.

5. The pattern verifying method according to claim 1, wherein, in the proximity correction, correction of the design layout data is performed such that, when photolithography is performed with exposure conditions fixed to best conditions, a dimension difference between a pattern on the wafer obtained by the photolithography and the pattern on the wafer obtained from the design layout data is minimized.

6. The pattern verifying method according to claim 1, wherein the verifying whether the pattern on the wafer satisfies the specification includes determining whether the pattern on the wafer transferred through photolithography process satisfies the specification even if photolithography condition including an exposure dose or a focus position in the photolithography process is varied.

7. The pattern verifying method according to claim 1, further comprising performing the proximity correction again when it is determined in the verification that the pattern on the wafer does not satisfy the specification.

8. The pattern verifying method according to claim 1, further comprising correcting the design layout data when it is determined in the verification that the pattern on the wafer does not satisfy the specification.

9. The pattern verifying method according to claim 1, further comprising changing a process condition when it is determined in the verification that the pattern on the wafer does not satisfy the specification.

10. The pattern verifying method according to claim 1, wherein the specification is set by using dimension information of the three-dimensional structures and characteristic values of materials of the layers of the semiconductor integrated circuit.

11. The pattern verifying method according to claim 1, wherein the specification is set by using functions of dimension information of the three-dimensional structures and characteristic values of the materials of the layers of the semiconductor integrated circuit.

12. A method of manufacturing a semiconductor device comprising:
setting, based on three-dimensional structures of layers of a semiconductor integrated circuit, a specification concerning a layout of a layout pattern arranged on a layer;
verifying whether a pattern transferred on a wafer based on design layout data subjected to proximity correction satisfies the specification; and
transferring a pattern onto a semiconductor substrate based on the design layout verified as satisfying the specification.

13. The method of manufacturing a semiconductor device according to claim 12, wherein the specification concerning the layout is a specification concerning an area of an overlapping section between the pattern on a wafer which is an impurity diffusing layer of a first layer and the pattern on a wafer which is a contact electrode of a second layer.

14. The method of manufacturing a semiconductor device according to claim 13, wherein the area of the overlapping section between the patterns on the wafer is set based on a function having an amount of an unevenness of the impurity diffusing layer as a variable.

15. The method of manufacturing a semiconductor device according to claim 14, wherein, when the an amount of an unevenness of the impurity diffusing layer is represented as h, a function having h as a variable is represented as f(h), and a contact area on a plane between the impurity diffusing layer and the contact electrode is represented S, a specification SP concerning an area of an overlapping section between the impurity diffusing layer and the contact electrode is given by SP=S+f(h).

16. The method of manufacturing a semiconductor device according to claim 12, wherein the specification concerning the layout is a specification concerning an area of an overlapping section between the pattern on a wafer of a selective epitaxial layer of a first layer and the pattern on a wafer of a contact electrode of a second layer.

17. The method of manufacturing a semiconductor device according to claim 16, wherein the area of the overlapping section between the patterns on a wafer is set based on a function having a tilt angle of the selective epitaxial layer as a variable.

18. The method of manufacturing a semiconductor device according to claim 17, wherein, when a tilt angle of the selective epitaxial layer is represented as θ and a contact area on a plane between the selective epitaxial layer and the contact electrode is represented as S, a specification SP concerning an area of an overlapping section between the selective epitaxial layer and the contact electrode is given by SP=S/cos θ.

19. A pattern verifying computer program product for causing a computer to execute:
verifying whether a pattern transferred on a wafer based on a design layout data subjected to proximity correction satisfies a specification concerning a layout of a layout pattern set based on three-dimensional structures of layers of a semiconductor integrated circuit.

20. The pattern verifying program product according to claim 19, wherein the specification concerning the layout is a specification concerning an area of an overlapping section between the patterns on the wafer of layers.
